(19) United States
(12) Patent Application Publication
(10) Pub. No.: US 2026/0302192 A1
(43) Pub. Date: Oct. 1, 2026

(54) ANODE FOR LITHIUM METAL BATTERY AND METHOD FOR MANUFACTURING THE SAME

(71) Applicant: GWANGJU INSTITUTE OF SCIENCE AND TECHNOLOGY, Gwangju (KR)

(72) Inventors: Kwang Sup EOM, Gwangju (KR); Chang Hyeon LEE, Gwangju (KR); Su Bin KIM, Gwangju (KR); Ki Yeon SIM, Gwangju (KR); Jin Hyeon JO, Gwangju (KR)

(21) Appl. No.: 19/555,621

(22) Filed: Mar. 3, 2026

(30) Foreign Application Priority Data
Mar. 27, 2025 (KR) 10-2025-0039268

(51) Int. Cl. H01M 4/38; H01M 4/66; H01M 4/02

(52) U.S. Cl. CPC H01M 4/382; H01M 4/661; H01M 4/667; H01M 2004/021; H01M 2004/027

(57) ABSTRACT

Disclosed is an anode for a lithium metal battery. The anode includes a copper current collector and an SEI layer formed on a surface of the copper current collector, the SEI layer comprising Li₂S₂/Li₂S_{X}, Li_{X}N, LiCl, and Li⁺ (X≥3). Accordingly, a uniform and stable SEI layer can be formed on a copper current collector, thereby suppressing lithium dendrite formation.

### CROSS-REFERENCE TO RELATED PATENT APPLICATION

This application claims the benefit of Korean Patent Application No. 10-2025-0039268, filed on Mar. 27, 2025, in the Korean Intellectual Property Office, the disclosure of which is incorporated herein in its entirety by reference.

### BACKGROUND OF THE INVENTIVE CONCEPT

### 1. Field of the Inventive Concept

The present inventive concept relates to an anode for a lithium metal battery and a method for manufacturing the same, and more particularly, to an anode which has a uniform and stable solid electrolyte interphase (SEI) layer through electrochemical surface treatment in the presence of a ligand and an acidic solution by utilizing the electrochemical corrosion properties of copper and to method for manufacturing the same.

### 2. Description of the Related Art

With the growth in global sales of electric vehicles (EVs), the demand for batteries having high energy density is also increasing. However, conventional lithium-ion batteries (LIBs) do not sufficiently satisfy the energy needed at EVs due to their low capacity.

Accordingly, lithium metal batteries (LMBs) have attracted much attention, because they can achieve a higher energy density than conventional LIBs by using metallic lithium (Li) as an anode material.

However, LMBs using lithium metal as an anode suffer from poor cycle life and serious safety issues. These issues arise from the high reactivity of lithium metal and the formation of an unstable solid electrolyte interphase (SEI) layer on its surface.

Conventional SEI layers are composed of rough and random composites of organic and inorganic compounds, and thus have weak mechanical strength, limited elasticity, and low stability, which lead to a degradation in cycle performance.

Such instability of SEI leads to continuous electrolyte decomposition and induces high film resistance due to the formation of a thick SEI layer, making it difficult to prevent lithium dendrite formation and volume expansion.

An unstable SEI also hinders the diffusion of lithium ion (Li⁺), leading to depletion of the electrolyte, and increases overpotential during lithium plating and stripping, thereby degrading the cycle life and safety of batteries. To address these issues, the formation of an artificial SEI (ASEI) has become a significant research subject.

Methods for introducing various electrolyte additives have been proposed to enable the ASEI to form a uniform and stable SEI layer. For example, additives such as lithium nitrate (LiNO₃) are used to form Li₃N as an inorganic component and suppress lithium dendrite growth.

Moreover, methods for suppressing lithium dendrite formation have also been investigated, including the surface treatment of a current collector using metal compounds such as Cu₃N, CuCl, and Ni₃S₂.

However, while conventional studies have focused on the chemical composition of the ASEI layer, the structural characteristics of the SEI layer, such as its uniformity, thickness, and surface morphology have been overlooked.

Therefore, the present inventive concept proposes a novel method capable of controlling both the chemical composition and surface uniformity of the ASEI layer.

### SUMMARY OF THE INVENTIVE CONCEPT

The present inventive concept has been made in an effort to solve the above-described problems associated with prior art, and a first object of the present inventive concept is to provide an anode for a lithium metal battery.

Moreover, a second object of the present inventive concept is to provide a method for manufacturing an anode for a lithium metal battery for achieving the first object.

In order to achieve the first object, the present inventive concept provides an anode for a lithium metal battery.

The anode for a lithium metal battery may comprise a copper current collector; and an SEI layer formed on a surface of the copper current collector, the SEI layer comprising Li₂S₂/Li₂S_{X}, Li_{X}N, LiCl, and Li⁺ (X≥3).

The SEI layer may have an average thickness of 2 nm to 4 nm.

The SEI layer may be formed through a reaction of an SEI precursor with an electrolyte containing lithium ions, wherein the SEI precursor is in the form of nanowires having a composition of [Cu(TU)ₙ]Cl (where n is 1 or 2). The TU is abbreviation of thiourea.

The SEI precursor may be randomly distributed on the surface of the copper current collector.

The SEI precursor may have a monoclinic crystal structure.

Furthermore, in order to achieve the second object, the present inventive concept provides a method for manufacturing an anode for a lithium metal battery.

The method for manufacturing an anode for a lithium metal battery may comprise the steps of: preparing a copper current collector; and growing an SEI precursor comprising a copper-thiourea complex by surface-treating the copper current collector.

The step of growing the SEI precursor may be performed in a precursor solution containing hydrochloric acid and thiourea.

The step of growing the SEI precursor may comprise the steps of: immersing the copper current collector in the precursor solution; modifying the surface of the copper current collector into a porous structure by using cyclic voltammetry (CV) on the copper current collector immersed in the precursor solution; forming nanowires on the surface of the porous structure of the copper current collector.

The step may further comprise forming an SEI layer through a reaction of the nanowires with an electrolyte containing lithium ions.

The SEI layer formed from the SEI precursor may comprise Li₂S₂/Li₂S_{X}, Li_{X}N, LiCl, and Li⁺ (X≥3).

According to the present inventive concept, an anode for a lithium metal battery and a method for manufacturing the same are provided. Accordingly, a uniform and stable SEI layer can be formed on a copper current collector, thereby suppressing lithium dendrite formation.

### BRIEF DESCRIPTION OF THE DRAWINGS

FIG. 1 is a schematic diagram and step-by-step SEM images of a method for manufacturing an SEI precursor according to an embodiment of the present inventive concept.

FIG. 2 is a schematic diagram illustrating the process of forming an SEI layer on a copper current collector according to an embodiment of the present inventive concept.

FIGS. 3A and 3B are SEM and TEM images of SEI layers formed according to an embodiment of the present inventive concept.

FIGS. 4A, 4b and 4C are XRD analysis graphs of an SEI precursor prepared according to an embodiment of the present inventive concept.

FIGS. 5A, 5B and 5C are XPS analysis graphs of an SEI precursor prepared according to an embodiment of the present inventive concept.

FIGS. 6A, 6B and 6C are XPS analysis graphs of SEI layers formed according to an embodiment of the present inventive concept.

FIGS. 7A and 7B show changes in Coulombic efficiency (CE) of half-cells according to an embodiment of the present inventive concept.

FIGS. 8A and 8B are EIS analysis graphs of half-cells after the 10^{th} and 60^{th} cycles according to an embodiment of the present inventive concept.

FIG. 9 shows the long-term cycling performance of symmetric cells according to an embodiment of the present inventive concept.

FIGS. 10A and 10B show the rate capability and cycling performance of full cells according to an embodiment of the present inventive concept.

### DETAILED DESCRIPTION OF THE INVENTIVE CONCEPT

Hereinafter, preferred embodiments of the present inventive concept will be described in more detail with reference to the accompanying drawings in order to provide a more specific description of the inventive concept. However, the present inventive concept is not limited to the embodiments described herein and may be embodied in other forms.

Throughout this specification, when a part is referred to as "including" a certain component, it is to be understood that, unless explicitly stated otherwise, the part may further include other components and does not exclude the presence of other components.

It will be understood that, when an element such as a layer, region, or substrate is referred to as being "on" another element, the element may be directly on the other element or may have one or more intervening elements therebetween.

It will be understood that, although the terms "first", "second", and the like may be used herein to describe various elements, components, regions, layers, and/or sections, such elements, components, regions, layers, and/or sections should not be limited by these terms.

Hereinafter, examples of the present inventive concept will be described in more detail with reference to the accompanying drawings.

### EMBODIMENT

The present inventive concept provides an anode for a lithium metal battery, comprising an SEI layer that may be formed through surface treatment of a copper current collector.

First, a copper current collector may be immersed in a precursor solution consisting of hydrochloric acid and thiourea (TU), followed by cyclic voltammetry (CV) and potentiostatic method. In this case, an SEI precursor comprising a copper-thiourea complex may be formed on the copper current collector. The SEI precursor may be randomly distributed on the copper current collector, and the SEI precursor is in the form of nanowires having a composition of [Cu(TU)ₙ]Cl.

An electrolyte may be introduced into a cell including the copper current collector, and the nanowires distributed on the copper current collector may react with lithium ions to form an SEI layer during charge and discharge cycles using the electrolyte and electrodes.

The SEI layer may comprise Li₂S₂/Li₂S_{X}, Li_{X}N, LiCl, and Li⁺ (X≥3). The mole fraction x represents that these materials have a non-stoichiometric composition, and denotes the mole ratio of sulfur to lithium in Li₂S_{X} and the mole ratio of nitrogen to lithium in Li_{X}N. Preferably, the mole fraction x may be 3 or more.

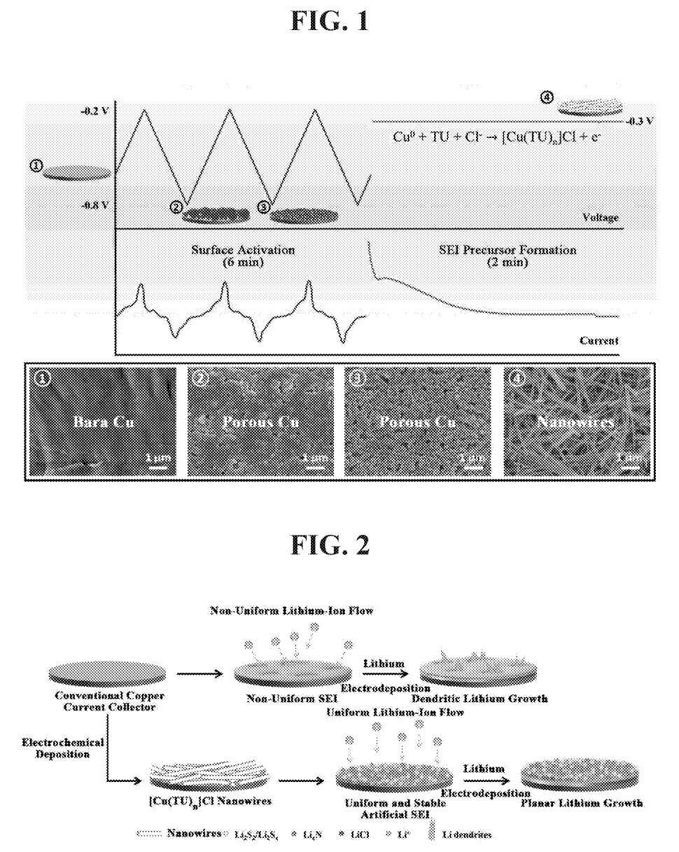

FIG. 1 is a schematic diagram and step-by-step SEM images of a method for manufacturing an SEI precursor according to an embodiment of the present inventive concept.

The SEM images are obtained using a field emission scanning electron microscope (JEOL JSM-7500, FE-SEM).

Referring to FIG. 1, before performing electrochemical surface treatment on a copper current collector, cyclic voltammetry (CV) is performed in an acidic solution containing 0.1 M thiourea within a voltage range of -0.85 V to 0 V to determine the voltage range at which copper is corroded.

Specifically, in the presence of a ligand such as thiourea, copper is readily oxidized and forms coordination bond with the ligand to form a complex. Oxidation is a form of corrosion.

In particular, thiourea can oxidize copper to Cu(TU)ₙ⁺ in an acidic solution. Accordingly, the voltage range at which copper is corroded is determined.

That is, the cyclic voltammetry may preferably be performed in a voltage range of -0.2 V to -0.8 V.

Subsequently, the copper current collector is immersed in a precursor solution having an acidic solution containing 0.1 M thiourea, followed by electrochemical surface treatment.

The acid may preferably be concentrated hydrochloric acid.

The electrochemical surface treatment may be performed by cyclic voltammetry or potentiostatic method.

Cyclic voltammetry is an electrochemical analysis method that measures the current according to voltage changes by scanning a constant voltage per unit time for a specific voltage range of an electrochemical cell. When a voltage reaches limited value, scanning continues by reversing the scanning direction.

The potentiostatic method is a testing method that allows for sufficient charging while maintaining a constant voltage. This method takes into account the problem that the interior of an electrode unlike its surface is not completely charged during charging.

Specifically, when the cyclic voltammetry is performed for 4 minute to 8 minute, the surface of the copper current collector is modified into a porous structure. This serves as a surface activation process for the copper current collector, where the increased porosity promotes the growth of an SEI precursor.

Subsequently, the potentiostatic method is performed at a constant voltage of -0.3 V for 1 minute to 3 minute to grow the SEI precursor on the porous copper current collector.

As described above, since thiourea can oxidize copper to Cu(TU)ₙ⁺ in an acidic solution, the SEI precursor may be in the form of a coordination complex where thiourea and chloride ions are coordinated to copper as a central metal, i.e., [Cu(TU)ₙ]Cl (where n is 1 or 2).

Furthermore, as shown in FIG. 1, the SEI precursor may be in the form of nanowires.

FIG. 2 is a schematic diagram illustrating the process of forming an SEI layer on a copper current collector according to an embodiment of the present inventive concept.

Referring to FIG. 2, the copper current collector prepared in the Comparative Example does not undergo electrochemical surface treatment, so lithium dendrite growth is not suppressed due to the presence of a naturally formed non-uniform SEI layer.

In contrast, the copper current collector prepared in the Preparation Example, in which nanowires are formed through electrochemical surface treatment, promotes the uniform flow of lithium ions, resulting in the formation of a uniform and stable SEI layer. This effectively suppresses lithium dendrite growth.

Specifically, the copper on the surface of the copper current collector is dissolved in a precursor solution containing hydrochloric acid and thiourea. This dissolved copper exists in an ionic form, and a portion thereof is restricted from diffusing far from the surface due to the presence of water molecules in the aqueous solution.

That is, the dissolved copper ions can be distributed at a high concentration adjacent to the surface of the copper current collector. Thiourea and chlorine atoms of the hydrochloric acid in the precursor solution participate in the synthesis of nanowires depending on the copper ion concentration.

Moreover, a porous structure is first formed on the surface of the copper current collector through cyclic voltammetry, and once the porosity exceeds a certain range, a large number of nanowires are synthesized on the surface of the copper current collector.

That is, in the present inventive concept, the nanowires are not formed through an instantaneous reaction on the surface of the copper current collector. Instead, their formation is driven by several factors. These factors include the dissolution of copper, the high concentration of copper ions distributed adjacent to the surface of the copper current collector, the presence of copper ions above a critical point, and the porosity of the surface of the copper current collector exceeding a critical point.

In this process, Cl⁻ and TU in the [Cu(TU)ₙ]Cl nanowires can be converted into LiCl and Li₂S₂/Li₂S_{X}, respectively, during the first discharge process.

The remaining TU promotes the decomposition of LiNO₃, which is an electrolyte additive, and through a strong hydrogen bond (N-H) between the two molecules, for example TU and LiNO₃, LiNO₃ is converted into Li₃N.

Therefore, an SEI layer comprising Li₂S₂/Li₂S_{X}, Li_{X}N, LiCl, and Li⁺ (X≥3) is formed on the copper current collector.

The average thickness of the SEI layer may range from 2 nm to 4 nm.

Next, preferred Preparation Examples and Measurement Examples are presented to facilitate understanding of the present inventive concept. However, the following Preparation Examples and Measurement Examples are provided only to facilitate the understanding of the present inventive concept, and the present inventive concept is not limited by the following Measurement Examples.

### Preparation Example: Preparation of A node with SEI P recursor

The SEI precursor is electrochemically deposited at room temperature using a potentiostat (Solartron 1285A, Solartron).

Electrochemical deposition (ECD) is performed by means of a three-electrode system using a saturated calomel electrode (SCE) and a platinum rod as a reference electrode and a counter electrode, respectively.

Commercially available Cu foil (18 μm thick) is rinsed several times with acetone to remove impurities and then used as a substrate for the working electrode.

The SEI precursor is grown in a solution consisting of concentrated hydrochloric acid (37% HCl/H₂O) and 0.1 M thiourea (TU, SC(NH₂)₂).

The pH of the electrolyte is adjusted to approximately 1.0 by adding HCl.

The electrochemical deposition is performed in two steps. First, for the surface activation process of the Cu foil, cyclic voltammetry (CV) is performed three times in a voltage range of -0.8 V to -0.2 V and a scan rate of 10 mV s⁻¹.

Subsequently, the SEI precursor is formed by performing potentiostatic method by applying a constant potential of -0.3 V for 120 seconds.

The entire ECD process is completed within 8 minutes. Thereafter, the sample is rinsed with deionized water and dried in a vacuum oven at 60°C for 1 hour.

Finally, the SEI precursor is electrochemically deposited on the Cu substrate, and the Cu substrate on which the SEI precursor is formed is cut into a disk for use as an anode in a coin cell.

### Preparation of Half-cell s

Li||[Cu(TU)ₙCl] nanowire-coated Cu half-cells are assembled.

1.0 M LiTFSI and 2 wt% LiNO₃ dissolved in 1,3-dioxolane (DOL) and 1,2-dimethoxyethane (DME) (v/v = 1:1) are used as the electrolyte.

### Preparation of Symmetrical Cells

Li@[Cu(TU)ₙCl] nanowire-coated Cu symmetric cells are assembled.

1.0 M LiTFSI and 2 wt% LiNO₃ dissolved in 1,3-dioxolane (DOL) and 1,2-dimethoxyethane (DME) (v/v = 1:1) are used as the electrolyte.

### Preparation of Full cells

LFP||Li@[Cu(TU)ₙCl] nanowire-coated Cu full cells are assembled.

1.0 M LiTFSI and 2 wt% LiNO₃ dissolved in 1,3-dioxolane (DOL) and 1,2-dimethoxyethane (DME) (v/v = 1:1) are used as the electrolyte.

### Comparative Example: Bare Cu Anode

A bare Cu anode is prepared.

### Preparation of Half-Cells

Li||bare Cu half-cells are assembled.

1.0 M LiTFSI and 2 wt% LiNO₃ dissolved in 1,3-dioxolane (DOL) and 1,2-dimethoxyethane (DME) (v/v = 1:1) are used as the electrolyte.

### Preparation of Symmetrical Cells

Li@bare Cu symmetric cells are assembled.

1.0 M LiTFSI and 2 wt% LiNO₃ dissolved in 1,3-dioxolane (DOL) and 1,2-dimethoxyethane (DME) (v/v = 1:1) are used as the electrolyte.

### Preparation of Full cells

LFP||Li@bare Cu full cells are assembled.

1.0 M LiTFSI and 2 wt% LiNO₃ dissolved in 1,3-dioxolane (DOL) and 1,2-dimethoxyethane (DME) (v/v = 1:1) are used as the electrolyte.

### Measurement Example 1: Morphological Analysis of Lithium Deposition

To investigate the effect of the SEI layer on the suppression of lithium dendrite growth, the morphology and behavior of lithium deposition are analyzed using scanning electron microscopy (SEM) and transmission electron microscopy (TEM).

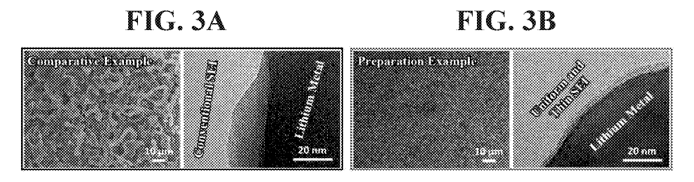

FIG. 3A and FIG. 3B are SEM and TEM images of SEI layers formed according to an embodiment of the present inventive concept.

The surface and cross-sectional morphologies of the samples are investigated using field emission scanning electron microscopy (FE-SEM, JSM-7500, JEOL), atomic force microscopy (AFM, XE-100, Park Systems), and transmission electron microscopy (TEM, Tecnai G2 F30 S-Twin, FEI).

Referring to the left SEM image of FIG. 3A, lithium dendrite growth is observed on the bare Cu anode of the Comparative Example, and lithium is deposited with a random distribution.

The uneven deposition of lithium metal on the bare Cu anode is attributed to the non-uniform surface properties of the SEI layer.

Furthermore, referring to the right TEM image of FIG. 3A, the bare Cu anode of the Comparative Example exhibits a thick and non-uniform SEI morphology.

In contrast, referring to the left SEM image of FIG. 3B, dense and uniform lithium growth is observed on the anode coated with the SEI precursor prepared in the Preparation Example.

In addition, referring to the right TEM image of FIG. 3B, the anode exhibits a uniformly thin morphology.

Therefore, it is considered that the inorganic SEI layer derived from the SEI precursor induces a uniform local current density and lithium-ion diffusion flux, thereby effectively suppressing lithium dendrite growth and improving the stability of the battery.

### Measurement Example 2: Structural and Chemical Properties of Nanowires as SEI Precursors

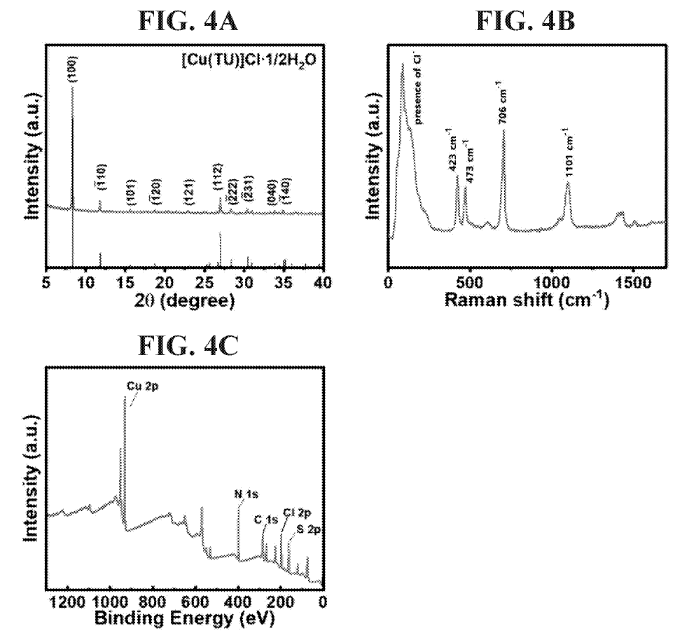

FIGS. 4A, 4B and 4C are XRD analysis graphs of an SEI precursor prepared according to an embodiment of the present inventive concept.

X-ray diffraction (XRD, RIGAKU, SmartLab) is performed to analyze the crystal structure of the copper-thiourea complex in a 2θ range of 5° to 80° at a scanning rate of 0.4° min⁻¹.

Referring to FIG. 4A, the nanowires, which are SEI precursors synthesized via the ECD process, exhibit a monoclinic crystal structure of Cu(TU)Cl·1/2H₂O.

The sharp and intense main peaks showing the directions of crystal planes indicate that the electrochemically deposited nanowires are highly crystalline.

Referring to FIG. 4B, the low-frequency region (25 cm⁻¹to 260 cm⁻¹) corresponds to the presence of Cl⁻, and the peaks at 423cm⁻¹, 473cm⁻¹, and 1101cm⁻¹ are associated with the in-plane bending vibration of N-C-N and the C-N stretching modes of the Cu-TU complex. A peak at 706cm⁻¹is assigned to the C=S stretching vibration.

This indicates that TU and Cl⁻ are coordinated to Cu.

Additionally, the broad peak between 1400 cm⁻¹ and 1436 cm⁻¹ represents the stretching modes of N-C-N, (N-C-N)⁺, and C=S, and the in-plane bending of NH₂⁺ of thiourea (H₂N-CS-NH₂).

Referring to FIG. 4C, the spectrum clearly exhibits the characteristic signals of S, Cl and N.

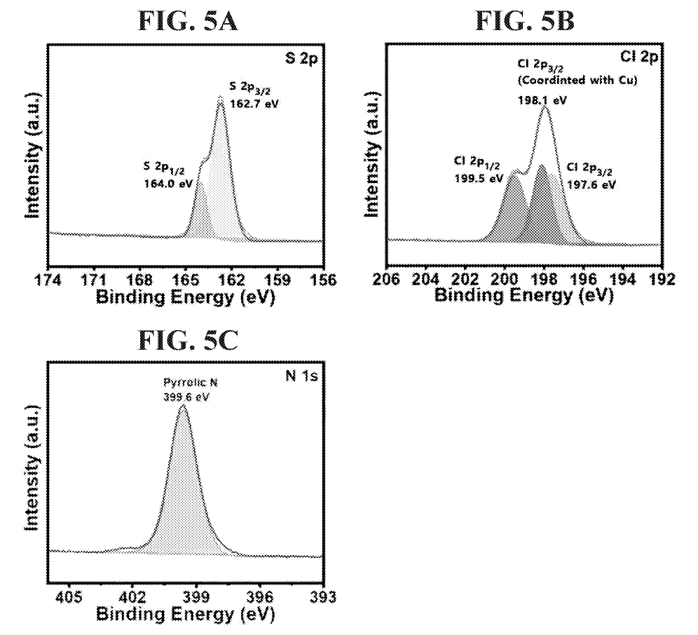

FIGS. 5A, 5B and 5C are XPS analysis graphs of an SEI precursor prepared according to an embodiment of the present inventive concept.

X-ray photoelectron spectroscopy (XPS, NEXSA, Thermo Fisher Scientific) is performed using an Al Kα radiation source to analyze the organic and inorganic groups of the sample, and Raman spectroscopy is performed using a 514 nm excitation laser (LabRAM HR Evolution, Horiba).

All XPS spectra are calibrated to the C-C bond peak (284.8 eV).

Referring to FIG. 5A, the peaks at 162.7eV and 164.0eV in the S 2p XPS spectrum are assigned to the S 2p_{3/2} and S 2p_{1/2} components of the S²⁻ species in the SEI precursor, respectively.

Referring to FIG. 5B, the Cl 2p XPS spectrum can be deconvoluted into three peaks representing Cl 2p_{1/2} (199.5eV), Cu-coordinated Cl 2p_{3/2} (198.1eV), and Cl 2p_{3/2} (197.6eV).

Referring to FIG. 5C, the peak at 399.6eV in the N 1s spectrum corresponds to the pyrrolic N of TU. This peak is indicative of the Cu-TU coordination.

It is confirmed from the above results that the SEI precursor is successfully synthesized into a Cu-TU complex in the form of nanowires through the ECD process.

### Measurement Example 3: Chemical Composition of SEI Layer

XPS analysis is performed to compare the chemical composition of the SEI layer formed on the bare Cu and nanowire electrodes after the 10^{th} stripping cycle.

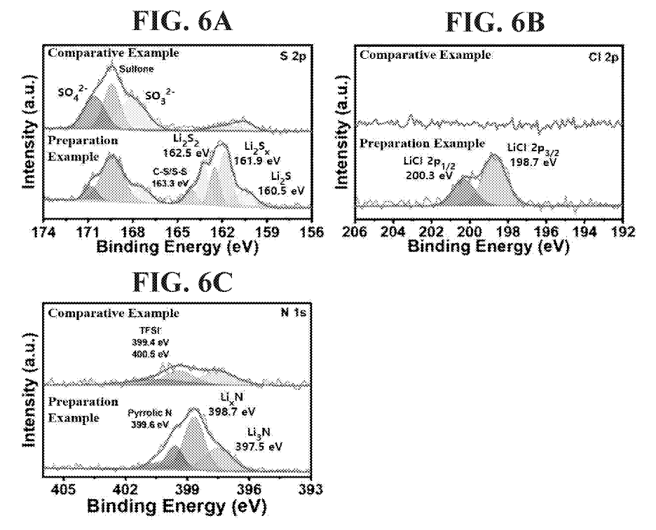

FIG. 6A, FIG. 6B and FIG. 6C are XPS analysis graphs of SEI layers formed according to an embodiment of the present inventive concept.

Referring to FIG. 6A, the peak intensities of Li₂S_{X} (161.9eV) and Li₂S (160.5eV) are significantly higher in the anode of the Preparation Example than the bare Cu anode of the Comparative Example.

Moreover, the peaks at 162.5eV and 163.3eV represent Li₂S₂ and C-S/S-S of inorganic polysulfides (Li₂S_{X}, x>3), respectively, which appear only in the SEI layer generated from the decomposition of the SEI precursor.

The sulfone group at approximately 169 eV detected in both anodes is attributed to a decomposition product of electrolyte salts such as lithium bis(trifluoromethane)sulfonimide (LiTFSI).

Referring to FIG. 6C, the N 1s spectrum shows the pyrrolic N (399.6eV) of residual TU, which promotes the decomposition of the LiNO₃ additive through hydrogen bonding (N-H).

Furthermore, the apparent peak of Li₃N (397.5eV) is higher in the anode of the Preparation Example.

Referring to FIGS. 6B and 6C, the Li_{X}N peak at 398.7eV is detected only in the anode of the Preparation Example due to the decomposition of the SEI precursor and the doublet separation in the Cl 2p spectrum corresponding to LiCl formation.

Consequently, the SEI precursor can serve as a source for the formation of an inorganic SEI layer including Li₂S₂/Li₂S_{X}, LiCl, and Li_{X}N.

### Measurement Example 4: Electrochemical Performance of Battery

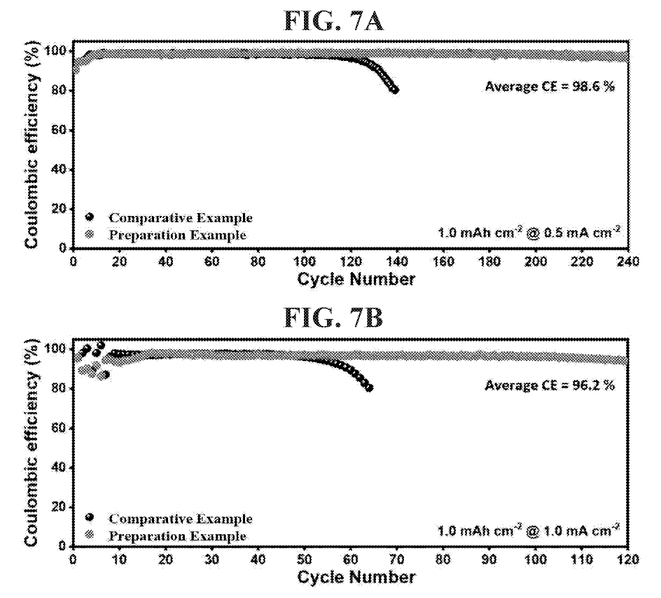

To investigate the influence of the inorganic SEI layer derived from the SEI precursor on the lithium plating/stripping, the electrochemical performance of half-cells from the Preparation Example and Comparative Example was compared, and the results are shown in FIGS. 7A and 7B.

FIG. 7A and FIG. 7B show changes in Coulombic efficiency (CE) of half-cells according to an embodiment of the present inventive concept.

Galvanostatic charge-discharge test is performed to evaluate the Coulombic efficiency of the half-cells at a current density of 1.0mA cm⁻².

Referring to FIG. 7A, the half-cells of the Preparation Example exhibit higher cycling stability and Coulombic efficiency for up to 240 cycles with an average CE of 98.6% at a current density of 0.5mA/cm⁻². In contrast, the half-cells of the Comparative Example last only 139 cycles with a CE of 97.4% under the same conditions.

Referring to FIG. 7B, when the current density is increased to 1.0mA/cm⁻², the half-cells of the Preparation Example exhibit better cycling performance (120 cycles, CE 96.2%), whereas the half-cells of the Comparative Example show poor cycle life and CE (64 cycles, CE 95.7%).

To evaluate the SEI resistance (R_{SEI}) and the lithium-ion diffusion coefficient, electrochemical impedance spectroscopy (EIS) is performed in a range of 0.1 Hz to 100 kHz after the 10^{th} and 60^{th} cycles at a capacity of 1 mAh/cm⁻² and a current density of 1 mA/cm⁻².

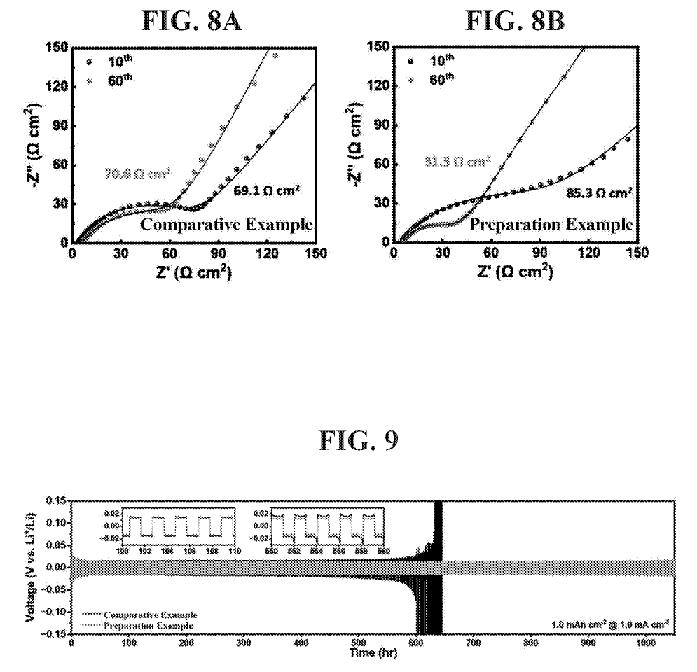

FIGS. 8A and 8B are EIS analysis graphs of half-cells after the 10^{th} and 60^{th} cycles according to an embodiment of the present inventive concept.

Referring to FIGS. 8A and 8B, at the 10^{th} cycle, the R_{SEI} of the half-cells of the Preparation Example (85.25 Ω cm²) is higher than that of the Comparative Example (69.09 Ω cm²). However, after the 60^{th} cycle, the R_{SEI} of the half-cells of the Preparation Example decreases to 31.52 Ω cm², whereas the R_{SEI} of the half-cells of the Comparative Example increases to 70.62 Ω cm².

Therefore, the EIS results demonstrate that the inorganic SEI layer derived from the SEI precursor contributed to stabilizing the Li metal/electrolyte interface and facilitating rapid lithium-ion diffusion, resulting in excellent electrochemical performance.

FIG. 9 shows the long-term cycling performance of symmetric cells according to an embodiment of the present inventive concept.

Referring to FIG. 9, at a capacity of 1.0mAh/cm⁻² and a current density of 1.0mA/cm⁻², the symmetric cells of the Preparation Example exhibit lower overpotentials during lithium plating/stripping, and maintain stable cycling for over 1,000 hours.

To verify the effectiveness of the lithium metal anodes having the inorganic SEI layer formed thereon in full cells, pre-lithiated Li electrodes on bare Cu and Li electrodes coated with [Cu(TU)ₙCl] nanowires are used as anodes and LFP is used as the cathode to fabricate the full cells.

The rate capability test is performed by increasing the rate from 0.1 C to 2 C.

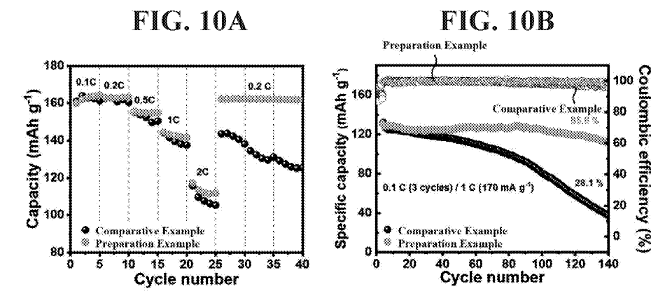

FIG. 10A and FIG. 10B show the rate capability and cycling performance of full cells according to an embodiment of the present inventive concept.

Referring to FIG. 10A, as the rate is increased from 0.1 C to 2 C, the full cells of the Comparative Example provide discharge capacities in the range of 161.3 mAh/g to 105.5 mAh/g, and exhibit poor capacity recovery when the rate is returned to 0.2 C.

In contrast, the full cells of the Preparation Example exhibit enhanced discharge capacities in the range of 164.3 mAh/g to 111.7 mAh/g and show remarkable capacity recovery, maintaining a capacity of 161.9 mAh/g when the rate is returned to 0.2 C.

Referring to FIG. 10B, during cycling stability test at 1.0 C, the specific capacity of the full cells of the Comparative Example decreases rapidly after the 50^{th} cycle, and the capacity retention also decreases to 28.1%.

Therefore, the inorganic SEI layer derived from the SEI precursor can effectively improve the stability of the lithium metal anodes by suppressing lithium dendrite formation and providing fast lithium-ion diffusion channels.

According to the present inventive concept described above, an anode for a lithium metal battery and a method for manufacturing the same are provided. Accordingly, a uniform and stable SEI layer can be formed on a copper current collector, thereby suppressing lithium dendrite formation.

While the inventive concept has been shown and described with reference to certain preferred embodiments thereof, it will be understood by those skilled in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

What is claimed is:

1. An anode for a lithium metal battery, comprising:
a copper current collector; and
an SEI layer formed on a surface of the copper current collector, the SEI layer comprising Li₂S₂/Li₂S_{X} Li_{X}N, LiCl, and Li⁺1(X≥3).

2. The anode of claim 1, wherein the SEI layer has an average thickness of 2 nm to 4 nm.

3. The anode of claim 1, wherein the SEI layer is formed through a reaction of an SEI precursor with an electrolyte containing lithium ions, the SEI precursor being in the form of nanowires having a composition of [Cu(TU)ₙ]Cl, wherein n is 1 or 2, and TU is thiourea.

4. The anode of claim 3, wherein the SEI precursor is randomly distributed on the surface of the copper current collector.

5. The anode of claim 3, wherein the SEI precursor has a monoclinic crystal structure.

6. A method for manufacturing an anode for a lithium metal battery, the method comprising the steps of:
preparing a copper current collector; and
growing an SEI precursor comprising a copper-thiourea complex by surface-treating the copper current collector.

7. The method of claim 6, wherein the step of growing the SEI precursor is performed in a precursor solution containing hydrochloric acid and thiourea.

8. The method of claim 7, wherein the step of growing the SEI precursor comprises the steps of:
immersing the copper current collector in the precursor solution;
modifying the surface of the copper current collector into a porous structure by using cyclic voltammetry (CV) on the copper current collector immersed in the precursor solution; and
forming nanowires on the surface of the porous structure of the copper current collector.

9. The method of claim 8, further comprises forming an SEI layer through a reaction of the nanowires with an electrolyte containing lithium ions.

10. The method of claim 9, wherein the SEI layer formed from the SEI precursor comprises Li₂S₂/Li₂S_{X} Li_{X}N, LiCl, and Li⁺ (X≥3).
